(19) United States
(12) Patent Application Publication
(10) Pub. No.: US 2025/0119016 A1
(43) Pub. Date: Apr. 10, 2025

(54) Ceramic Substrate Windings for Permanent Magnet Machines

(71) Applicant: North Carolina State University, Raleigh, NC (US)

(72) Inventors: Ritvik Chattopadhyay, Raleigh, NC (US); Iqbal Husain, Raleigh, NC (US); Md Sariful Islam, Raleigh, NC (US)

(21) Appl. No.: 18/911,386

(22) Filed: Oct. 10, 2024

Related U.S. Application Data
(60) Provisional application No. 63/543,397, filed on Oct. 10, 2023.

(51) Int. Cl. H02K 3/26; H02K 1/12; H02K 3/02; H02K 9/19; H02K 9/22

(52) U.S. Cl. CPC H02K 3/26; H02K 1/12; H02K 3/02; H02K 9/19; H02K 9/227

(57) ABSTRACT

Various examples are provided related to ceramic substrate windings and their application. In one example, a ceramic substrate coil includes a ceramic substrate and at least one coil trace disposed on a first surface of the ceramic substrate, the at least one coil trace forming at least a partial loop about the ceramic substrate surface. In another example, a permanent magnet machine includes a rotor and a stator including ceramic coils. Each of the ceramic coils include a ceramic substrate and at least one coil trace disposed on a first surface of the ceramic substrate. The ceramic coils are positioned, and the coil traces are connected to form a stator winding of the permanent magnet machine.

### CROSS REFERENCE TO RELATED APPLICATIONS

This application claims priority to, and the benefit of, U.S. provisional application entitled “Ceramic Substrate Windings for Permanent Magnet Machines” having Ser. No. 63/543,397, filed Oct. 10, 2023, which is hereby incorporated by reference in its entirety.

### BACKGROUND

Permanent Magnet Synchronous Machines (PMSMs) are the most commonly used machines in aerospace propulsion and automotive traction applications due to their high torque and power density. Conventional PMSMs use stranded conductors for windings. These occupy a large volume within the machine and have poor effective thermal conductivity due to poor fill factor and the presence of insulation film, which limits the maximum current density.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 schematically illustrate examples of active metal brazing (AMB) and conventional wire windings, in accordance with various embodiments of the present disclosure.

FIGS. 2A-2C illustrate an example of a ceramic coil and a stator comprising ceramic coils, in accordance with various embodiments of the present disclosure.

FIGS. 3 and 4 illustrate examples of back EMF and torque profile of a motor comprising ceramic coils, in accordance with various embodiments of the present disclosure.

FIG. 5 illustrates an example of loss distribution in an AMB winding, in accordance with various embodiments of the present disclosure.

FIG. 6 illustrates an example of total eddy current loss as a function of magnet height and trace width, in accordance with various embodiments of the present disclosure.

FIG. 7 illustrates an example of the torque as a function of magnet weight, in accordance with various embodiments of the present disclosure.

FIG. 8 illustrates an example of torque density as a function of magnet thickness, in accordance with various embodiments of the present disclosure.

FIG. 9 illustrates an example of torque-speed characteristics of a slotless machine with and without an inductor, in accordance with various embodiments of the present disclosure.

FIG. 10 illustrates an efficiency map of the slotless machine with the inductor, in accordance with various embodiments of the present disclosure.

FIGS. 11 and 12 illustrate examples of loss distributions at base and maximum speeds, in accordance with various embodiments of the present disclosure.

FIGS. 13 and 14 illustrate examples of temperature distributions at base and maximum speeds, in accordance with various embodiments of the present disclosure.

FIG. 15 schematically illustrates an example of an axial flux permanent magnet machine with AMB windings, in accordance with various embodiments of the present disclosure.

FIG. 16A is an image of a set of coils in an axial flux permanent magnet machine with AMB windings as fabricated with copper on aluminum nitride (AlN) substrate, in accordance with various embodiments of the present disclosure.

FIG. 16B is an image of a complete stator coil assembly in an axial flux permanent magnet machine with AMB windings, in accordance with various embodiments of the present disclosure.

### DETAILED DESCRIPTION

Disclosed herein are various examples related to ceramic substrate windings which can be used in permanent magnet machines. Reference will now be made in detail to the description of the embodiments as illustrated in the drawings, wherein like reference numbers indicate like parts throughout the several views.

Slotless machines with high pole count are gaining increasing interest for the next generation aerospace applications that include drones, flying cars, and electrified aircraft. Slotless motors with Halbach array magnets in the rotor are lightweight due to reduced lamination volume in the stator and absence of lamination materials in the rotor. However, the reduced lamination results in low inductance, which in turn increases the electrical loading. Printed windings allow for further reduction in volume and mass through reduction in effective airgap of slotless machines. At the same time, it also reduces flux leakage. Both of these factors contribute towards improving the power density. PCB windings may be used for slotless machines, however conventional PCBs have limited current carrying capacity. To accommodate the needed amount of current density in the slot, the design will require a larger number of turns in a multi-layer PCB winding configuration. This will increase the manufacturing complexity and associated cost.

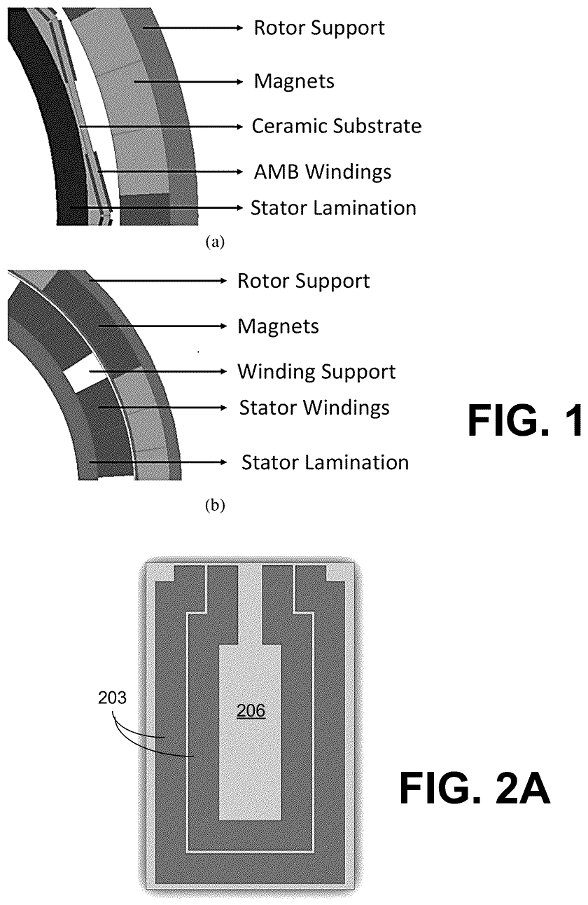

The use of ceramic substrates results in higher current carrying capacity due to the high thermal conductivity of the ceramic substrate. Direct bonded copper (DBC) and active metal brazing (AMB) are techniques that can be used for producing copper-on-ceramic circuitry. Materials that can be used for the ceramic substrate include alumina (Al₂O₃) and aluminum nitride (AlN). While the use of ceramic substrates is common in power electronics, it has not been utilized in the fabrication of motor windings. In this disclosure, a novel radial flux slotless motor with AMB windings on aluminum nitride substrate is presented. FIG. 1 shows a closeup of a motor schematic with AMB windings (top) and a closeup of a motor schematic with conventional wire windings (bottom). Due to the higher thickness of copper metallization permitted by AMB, it has been chosen over DBC as the thickness of copper film in the latter is restricted to 0.3 mm in commercially available examples. The higher copper thickness permitted by AMB also enables reduction of trace width, which can greatly mitigate the eddy current losses in the windings. The use of AMB windings can increase the power density of the machine in two ways: First, the reduction in winding volume decreases the total volume of the machine, as seen in FIG. 1, and second, the use of low thickness AMB windings reduces the effective air gap of the machine, which in turn increases flux linkage and thus electromagnetic torque.

### Active Metal Brazed Copper Windings

Active metal brazing is a technology that is used in the manufacture of power semiconductor substrates. It involves utilizing a brazing alloy, typically composed of silver, copper, and titanium, to form a bond between the copper conductor and the ceramic substrate.

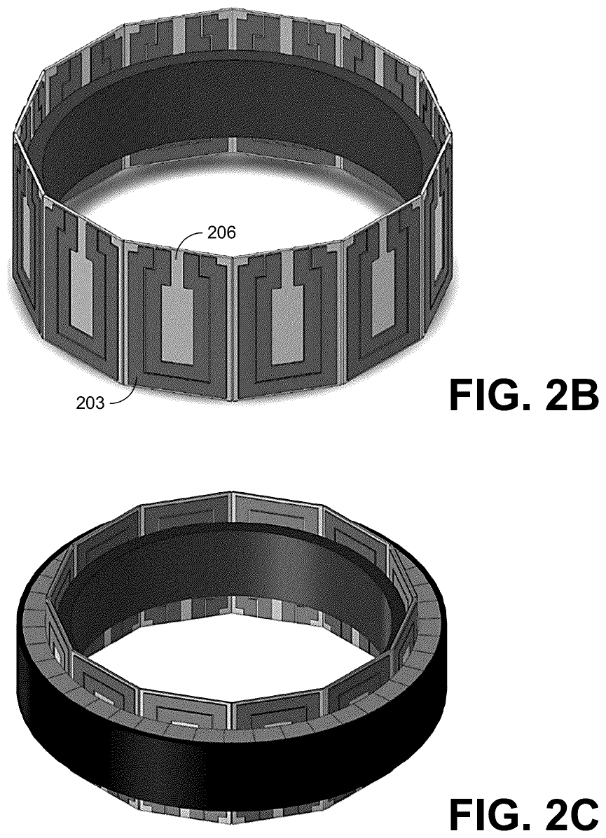

For the slotless machine presented in this research, each coil is individually fabricated using double-sided AMB copper on a rectangular substrate. Each coil comprises 4 turns which are realized by etching 2 traces on each side of a ceramic substrate. FIG. 2A illustrates an example of one side of a coil comprising two traces 203 disposed on a side of the ceramic substrate 206. The other two traces can be duplicated on the opposite side of the ceramic substrate 206. This configuration also enables short pitched and double layer windings. The traces 203 on either side of the substrate 206 may be connected either using conducting vias or using external wire bonds. AMB technology also permits lead type connectors to be fabricated, and thus, inter-coil and inter-turn connections can be made using external wires soldered to the copper metallization. In the fabricated example, the spacing between the copper traces is 0.5 mm, however other spacing can be used. The substrate 206 and traces 203 can be extended axially beyond the active length of the machine where the individual turns may be connected in series using external bond wires. The terminals of each coil can then be connected either in series or parallel to other coils of the same phase, depending on the inverter rating. In this disclosure, all the coils in a phase are assumed to be connected in series. There are a total of 12 coils, arranged in a 14-pole configuration, thus necessitating 12 individual substrates which are then laid out in the arrangement shown in FIG. 2B. The stator and the outer rotor configuration is shown in FIG. 2C.

Each turn of the AMB windings considered in this disclosure comprises a copper metallization thickness of 0.5 mm and width of 4.75 mm. According to the design rules of ceramic substrates, a trace width of 1 mm with a copper metallization thickness of 0.3 mm can carry 100 A continuously for a temperature rise below 20° C. in DBC substrates. The use of AMB would further enhance the current-carrying capacity. The substrate chosen was aluminum nitride (AlN) which is preferred due to its high thermal conductivity of 170 W/mK.

Apart from the thermal and power density improvements, the use of ceramic substrates for the windings also improves the structural integrity of the stator, as the flexural strength of AlN ceramic is higher than plastic which is typically used in slotless machine winding supports.

### Electromagnetic Design

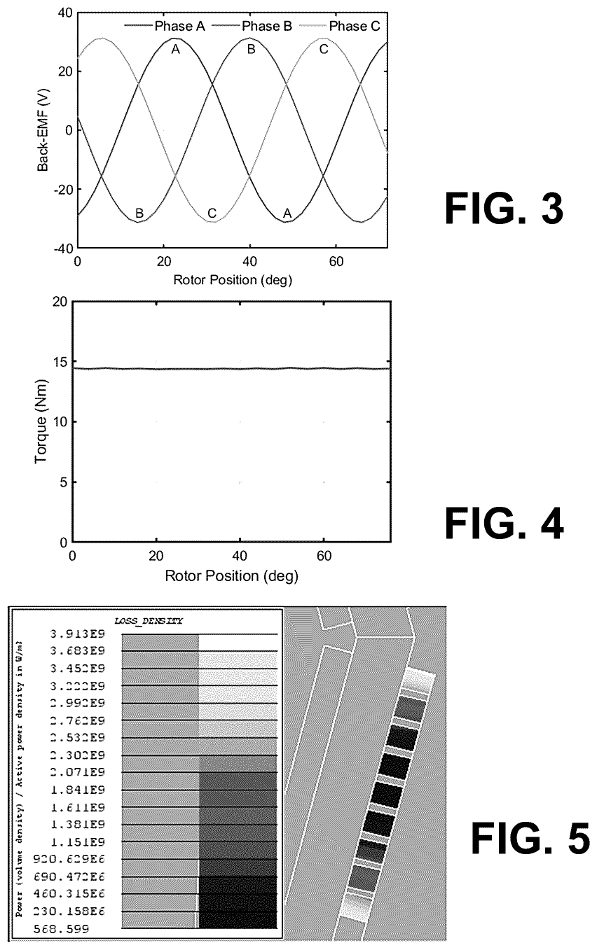

A 10.5 kW, 7,000 rpm outer rotor slotless motor with Halbach array magnets was designed with the proposed AMB windings. Due to the high current carrying capacity of the AMB copper traces 203, the number of turns in the windings can be kept low. This, combined with the low inductance of slotless machines, allows the machine to be operated at relatively low voltages at higher speed. The inductance per phase of the designed machine was found to be only 27 μH per phase. This machine's ratings were derived by scaling down from the DoE 2025 roadmap targets. The FEA extracted back-emf and torque profile of the machine at the base speed and rated current is shown in FIGS. 3 and 4, respectively. FIG. 3 illustrates an example of the back EMF of the motor at the base speed of 7,000 rpm and FIG. 4 illustrates an example of the torque profile of the motor at rated power of 10.5 kW.

The mechanism through which the use of AMB windings reduces the electrical loading in the machine can be explained by studying the air gap flux density. The no-load magnetic flux density in the airgap is expressed as:

$${B}_{mg} = \frac{μ {F}_{m}}{{g}^{′}} , \qquad ( 1 )$$

where μ is the permeability of air, Fₘ is the excitation MMF provided by the magnet and g′ is the equivalent air gap. The back-emf per phase induced by this magnetic field is

$${E}_{b} = 2 \sqrt{2} {fNk}_{w 1} τ {l}_{s} {B}_{mg} , \qquad ( 2 )$$

where ƒ is the operating frequency, N is the turns per phase, k_{w1} is the winding factor, τ is the pole pitch, and lₛ is the stack length. Finally, the torque per phase can be expressed as the product of the back-emf and current divided by the speed

$${T}_{e} = \frac{{E}_{b} {I}_{n}}{{ω}_{r}} = \frac{1}{\sqrt{2} π {g}^{′}} {PNk}_{w 1} τ {l}_{s} μ {F}_{m} {I}_{a} , \qquad ( 3 )$$

where ωᵣ is the rotor speed, P is the number of poles, and Iₐ is the phase current. Therefore, by reducing the effective air gap g′, the ampere-turns needed to produce the same torque can be reduced.

### Copper & Eddy Current Losses

Due to the lack of highly saturated magnetic teeth in the stator, the primary source of losses in a slotless motor are the copper and eddy current losses in the stator conductors. Making the copper traces wider provides more area of cross section for the current to flow through, reducing the copper losses per coil, given by:

$${P}_{Cu} = {I}_{a}^{2} \frac{2 ρ ( {l}_{s} + {l}_{ew} )}{{N}_{t} tw} , \qquad ( 4 )$$

where l_{ew} is the end winding length, t is the conductor thickness, w is the width of the conductor trace, and Nₜ is the number of turns per coil. However, increasing the trace width also results in a sharp increase in eddy current losses which depend on the third power of the trace width.

When designing slotless motors, special attention needs to be given to the eddy current losses since, unlike a slotted machine, the magnetic flux flows through the windings in this type of machine. This results in higher flux densities in the windings, and therefore, higher eddy current loss. The eddy current loss in the rectangular winding conductors is given by:

$${P}_{e} = \frac{{π}^{2}}{6} {B}_{m}^{2} {f}^{2} {w}^{3} σ tl , \qquad ( 5 )$$

where Bₘ is the average flux density in the conductor, ƒ is the operating frequency, t is the conductor thickness, σ its conductance, w and l the width and length of the conductor trace, respectively. In a slotless machine, since the windings are located in the airgap, the flux density in the conductors can be assumed to be equal to the airgap flux density, which is given by:

$${B}_{ag} = \frac{2 {B}_{r} P}{M ( 1 - 1 \frac{P}{2} )} ( 1 + {μ}_{rec} ) [ 1 - {( \frac{{R}_{r}}{{R}_{m}} )}^{P / 2 - 1} ] [ 1 + {( \frac{{R}_{i}}{r} )}^{P} ] {( \frac{r}{{R}_{r}} )}^{P / 2 - 1} cos ( \frac{P}{2} θ ) , \qquad ( 6 )$$

where M is the equivalent amplitude of magnetization given by:

$$M = 2 [ ( 1 - {μ}_{rec} ) [ ( 1 - {μ}_{rec} ) {( \frac{{R}_{r}}{{R}_{m}} )}^{P} + ( 1 + {μ}_{rec} ) {( \frac{{R}_{i}}{{R}_{m}} )}^{P} ] - ( 1 + {μ}_{rec} ) [ ( 1 + {μ}_{rec} ) + ( 1 - {μ}_{rec} ) {( \frac{{R}_{i}}{{R}_{m}} )}^{P} ] , \qquad ( 7 )$$

where Bᵣ is the remanent magnet flux density, μ_{rec} is the recoil permeability of the magnet, r is the mean radius of the air gap, and Rᵢ, Rᵣ, and Rₘ are the internal radius of the slotless winding, magnet inner radius, and magnet outer radius, respectively.

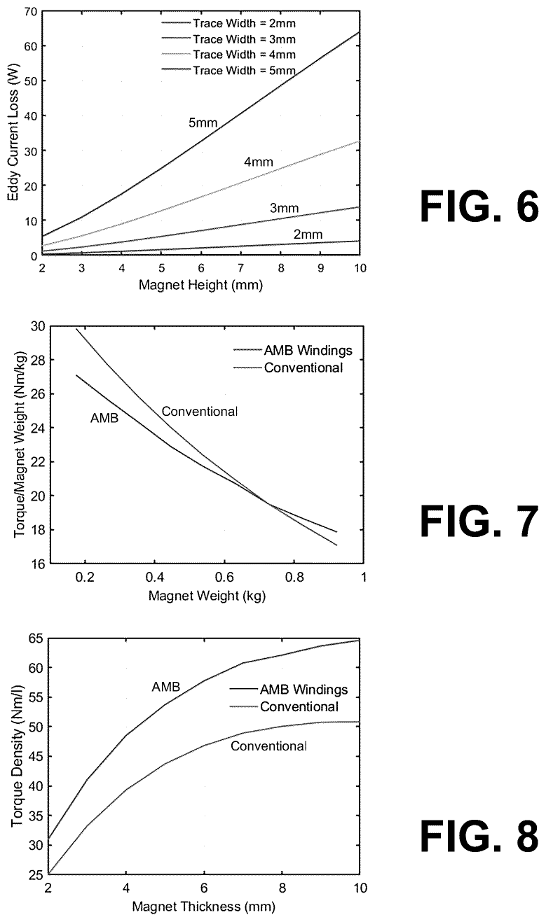

In order to mitigate the eddy current loss in the AMB windings, each turn can be further subdivided into a number of parallel paths. In the design presented, each turn is divided into 9 parallel traces for the active length of the stator, as shown in FIG. 5 which illustrates the loss distribution in the AMB windings. The unequal distribution of current density, and therefore, loss density may be attributed to the proximity effect caused by the currents in the neighboring conductors. FIG. 6 illustrates an example of the total eddy current loss as a function of magnet height and trace width. As seen in FIG. 6, the increase in trace width dramatically increases the total eddy current loss in the windings, and the effect is compounded by increasing the magnet thickness, which increases the air gap flux density but is necessary for achieving good power density. The eddy current losses in all the traces of the machine determined using FEA and the analytical method presented is compared in Table I.

TABLE I
EDDY CURRENT LOSSES IN WINDING TRACES

| Method | FEA | Analytical |
|---|---|---|
| Eddy Current Loss (W) | 25.68 | 25.02 |

At the frequency corresponding to a speed of 20,000 rpm, the skin depth of the copper windings, given by δ=\sqrt{1/(λfμ₀σ)} was found to be 1.35 mm, which is larger than the thickness of the traces. Therefore, the skin effect is negligible and the AC resistance is the same as the DC resistance in the entire operating range of the studied motor.

### Torque Density

The use of AMB windings facilitates reduction in stator volume which in turn improves the torque density of the motor. FIG. 7 illustrates an example of the torque per unit magnet weight as a function of magnet weight. From FIG. 7, it is seen that the torque per unit magnet weight achieved using both AMB windings and conventional windings are similar, however, due to the much smaller stator volume of the motor with AMB windings, the overall torque density is much higher. FIG. 8 illustrates an example of torque density as a function of magnet thickness. Moreover, the effect of increasing the magnet volume on torque density saturates at higher magnet volumes in the motor with conventional windings, as the effective air gap becomes very large. Therefore, the use of AMB windings results in improved magnet utilization at higher magnet volumes and enables higher torque densities which would not be possible with conventional windings.

### Flux Weakening

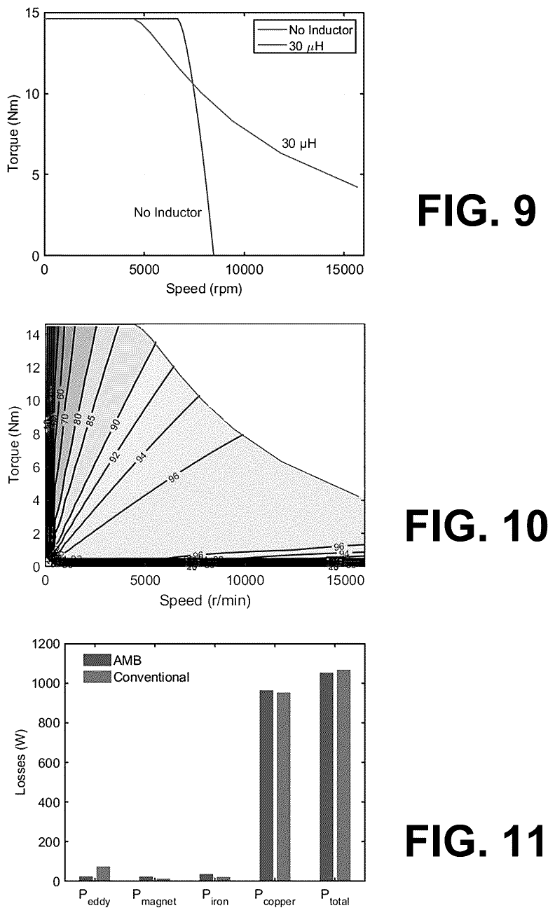

Surface-mounted PM motors generally have poor flux weakening capability due to the large magnet flux linkage which results in a high characteristic current. The low inductance in a slotless machine further impacts the flux weakening capability adversely. However, this can be improved by the addition of an external inductor in each of the three phases. FIG. 9 illustrates an example of torque-speed characteristics of the slotless machine with and without an inductor. As seen in FIG. 9, the ratio of maximum speed to base speed of the studied motor without external inductance is 1.3:1. Moreover, the power is not constant along the torque-speed envelope in the field weakening region. An external inductor of 30 μH was added in series to each phase. As shown by the second curve in FIG. 9, the addition of the 30 μH external inductor improved the CPSR to 3.3:1, at the cost of a reduction in the base speed to 4800 r/min. This can be understood by considering the equation for base speed, neglecting the stator resistance drop:

$${ω}_{b} = \frac{2 {V}_{ph \cdot max}}{P \sqrt{{λ}_{pm}^{2} + ( {L}_{q} + {L}_{ext} ) {i}_{s}^{2}}} , \qquad ( 8 )$$

where P is the number of poles, V_{ph,max} is the maximum phase voltage allowed depending on the DC bus voltage and modulation scheme, λₚₘ is the magnet flux linkage, L₁ is the q-axis inductance, Lₑₓₜ is the external inductor, and iₛ is the rated stator current. The d-axis inductance is equal to the q-axis inductance in SPM motors like the one presented in this disclosure. Similarly, the maximum speed can be calculated when i_{q}=0 and i_{q}=−iₛ:

$${ω}_{max} = \frac{2 {V}_{ph \cdot max}}{P ( {λ}_{pm} - ( {L}_{d} + {L}_{ext} ) {i}_{s} )} . \qquad ( 9 )$$

In this case, since the inductive voltage drop opposes the back emf, the maximum speed is increased for a given bus voltage.

From Eqs. (8) and (9), it is clear that the addition of an external inductor would reduce the base speed for a given bus voltage, while increasing the maximum speed. Therefore, the overall effect of a series inductance in each phase is to significantly improve the CPSR with only a moderate penalty to the peak power. The reduction in peak power can be addressed by switching in the inductor only beyond the point where the two torque speed envelopes in FIG. 9 intersect after the base speed; however, this would add to the complexity of the drive circuit and control.

### Efficiency Map

The efficiency map can be generated by calculating the copper loss, eddy current loss, iron loss and magnet loss for various points within the torque-speed envelope of the machine. The calculation of eddy current losses has been previously discussed. The magnet loss was calculated from FEA, and the iron loss was determined by post-processing the flux density from FEA using Bertotti's three term model given by:

$${P}_{Fe} = {k}_{hyst} {fB}^{2} + {k}_{eddy} {f}^{2} {B}^{2} + {k}_{exe} {f}^{1.5} {B}^{1.5} , \qquad ( 10 )$$

where the first, second, and third terms represent the losses due to hysteresis, eddy currents, and excess losses, respectively, and k_{hyst}, k_{eddy}, and k_{exc} are coefficients depending on the material properties. The efficiency map of proposed design with 30 μH external inductor over the entire torque-speed range is seen in FIG. 10, and it is evident from the high efficiency at higher speeds that the speed dependent losses are minimal in the proposed machine. Iron losses can be mitigated by the elimination of stator teeth, while eddy current losses in the windings can be reduced by the use of narrow winding traces in place of conventional wire windings. Overall efficiency at the base speed is also improved over conventional slotless machines through reduction of eddy current losses in the stator conductors.

### Comparison with Magnet Wire Windings

To demonstrate the improvements offered by the AMB windings, the slotless machine presented in this disclosure was compared to one with the same power rating but employing conventional 20 AWG magnet wire windings. The comparison is presented in Table II. As seen from the comparison, the use of direct bonded copper results in a 50% reduction in the effective air gap, which translates to a 46% reduction in the ampere-turns needed to achieve the same torque rating. The eddy current losses are also significantly lowered from 76 W to 25 W which resulted in a power density improvement by 20%. Since this is an outer rotor topology, the power density is calculated as Pₒᵤₜ/(π(rᵣₒ²−rₛᵢ²)lₛ), where rᵣₒ and rₛᵢ are the rotor outer radius and stator inner radius, respectively.

TABLE II
COMPARISON OF SLOTLESS MOTOR TOPOLOGIES

| | Slotless Motor w/ | Slotless Motor w/ |
|---|---|---|
| Parameter | AMB windings | wire windings |
| Output Torque (Nm) | 14.4 | 14.4 |
| Base Speed (r/min) | 7000 | 7000 |
| Output Power (kW) | 10.5 | 10.5 |
| Amp-turns/coil | 637 | 1186 |
| Physical airgap (mm) | 1 | 1 |
| Effective airgap (mm) | 5.0 | 10.0 |
| Rotor OD (mm) | 150 | 150 |
| Stator ID (mm) | 110 | 100 |
| Stack Length (mm) | 28 | 28 |
| Power Density (kW/L) | 43.7 | 36.4 |
| Copper Loss (W) | 963 | 952 |
| Eddy Current Loss (W) | 25 | 76 |
| Magnet + Iron Loss (W) | 62 | 38 |
| Efficiency | 91.0% | 90.8% |

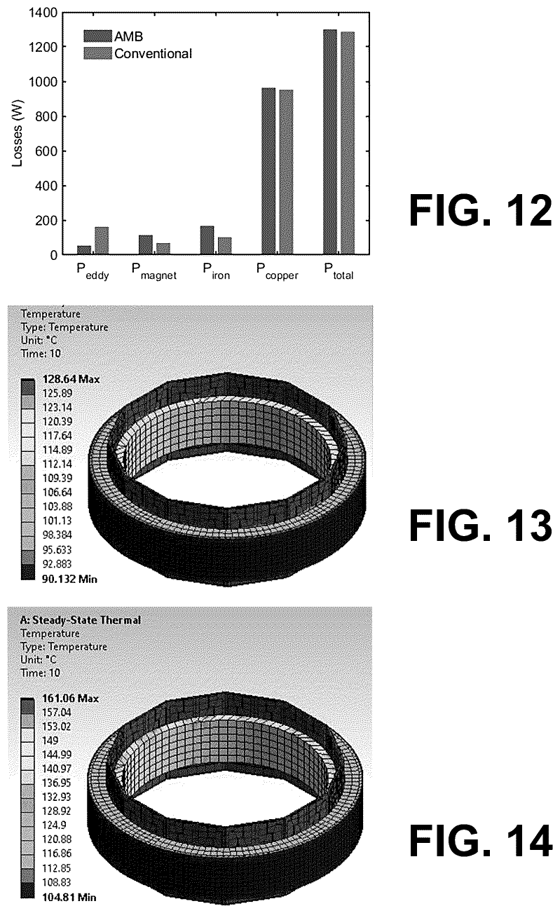

Although the magnet and iron losses are elevated as the reduced air gap results in higher saturation, the overall efficiency at peak power and peak torque is improved while simultaneously improving the power density compared to the slotless machine with magnet wires. The distribution of losses at base speed (7000 r/min) and maximum speed (15,000 r/min) at rated power is shown in FIGS. 11 and 12, respectively. As mentioned before, the reduction in eddy current losses achieved by the use of AMB windings is sufficient to achieve a better efficiency at the base speed of 7,000 r/min despite having higher copper, iron, and magnet loss. At maximum speed, even though the eddy current losses are much lower than the conventional design, the higher flux densities in the stator lamination of the AMB design result in higher iron losses which results in overall higher losses compared to the motor with conventional windings. However, this slight reduction of efficiency at maximum speed is a small cost for the large improvement in power density enabled by the AMB windings without an increase in the stator excitation.

### Thermal Performance

In terms of thermal performance, AMB windings offer a huge advantage over conventional windings and even slotted motors with the AMB substrate becoming part of the thermal management system. The high thermal conductivity (170 W/mK) of the AlN substrate conducts heat away from the windings much more effectively as there is no air between the copper conductors and stator lamination as is the case with magnet wire windings. The thermal contact between the windings and substrate is also better than in conventional windings as the copper is directly brazed rather than wound around a winding support. To evaluate the thermal performance of the proposed design, a thermal FEA simulation was performed using Ansys Mechanical. It was assumed that the stator is cooled by a spiral water jacket, as is typical of high power density machines, and a heat transfer coefficient of 500 W/m² K was applied on the inner surface of the stator lamination to emulate the water jacket. The convection coefficient at the outer rotor surface is dependent on the rotor speed and was found to be 30.63 W/m² K at 7,000 r/min and 56.35 W/m² K at 15,000 r/min. The temperature distribution at these speeds is shown in FIGS. 13 and 14, respectively.

A novel slotless machine has been designed using active metal brazed copper on aluminum nitride ceramic substrate for the windings. The designed motor has a significantly reduced airgap compared to conventional wire wound slotless machines. This results in a reduction in excitation needed to achieve a given torque. As a result, the winding volume and the entire machine volume is reduced, which in turn improves the power density significantly. The AC eddy current losses in the windings are significantly improved as the copper traces are only 0.5 mm thick. The disclosed machine design is therefore suitable for high speed and high power density applications such as aircraft propulsion. Widening the field weakening region of the proposed machine using external inductors has also been disclosed. The excellent thermal performance of the AMB windings enabled by the high thermal conductivity of the ceramic substrate has also been analyzed using thermal FEA. The ceramic substrate can be either direct bonded copper, electroplated copper, or active metal brazed copper, depending on the needed thickness of copper. The use of ceramic windings can be applied to radial flux, axial flux, and 3D airgap machines. They can also be applied for slotted and slotless stators. The use of ceramic windings with Aluminum Nitride substrate can reduce the winding volume by 50% and increase the overall power density by 20% in case of a radial flux slotless machine. Similar results are expected for other motor topologies.

### Axial Flux Machine with Ceramic Substrate Windings

Ceramic substrate windings can be used in axial flux machines due to the planar form of the ceramic windings. They can be utilized in machines with combinations of one or more rotors and/or one or more stators. The winding configuration emulated using ceramic substrate coils is a two-layer, fractional slot winding with a coil span of one. Due to the non-overlapping nature of the winding, each coil can be individually fabricated on separate substrates, with each substrate having one turn on each side, thus forming two turns per coil.

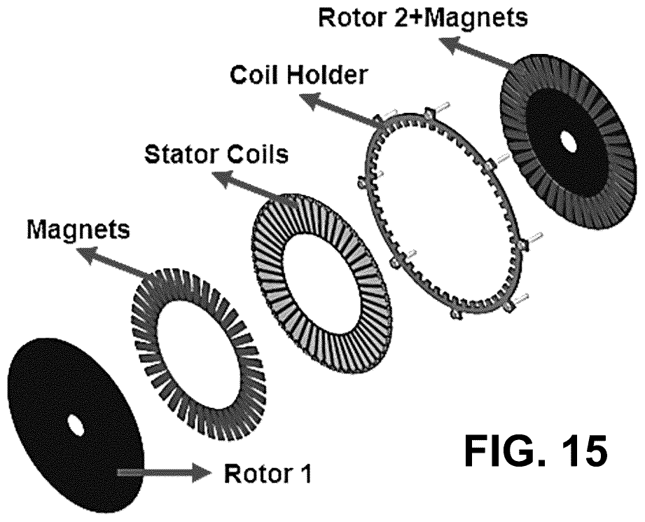

FIG. 15 shows an exploded view of an example of an entire motor assembly, including the two rotor yokes, magnets, and coil holders. The dual rotor structure bypasses the need of magnetic material in the stator because the return path for magnet flux is provided by the second rotor. This also eliminates the need for low-specific loss soft magnetic composites in the machine construction as the only soft magnetic material is in the rotor yoke, where the losses are expected to be low.

As an example, a 48 coil/40 pole, dual rotor CS-CAFM prototype was fabricated. Each coil was fabricated on an individual AlN substrate with a thickness of 0.635 mm. The double-sided copper conductor traces deposited on each surface of the AlN substrate have a thickness of 0.3 mm, with the end connections between coils made by soldering wire leads between them.

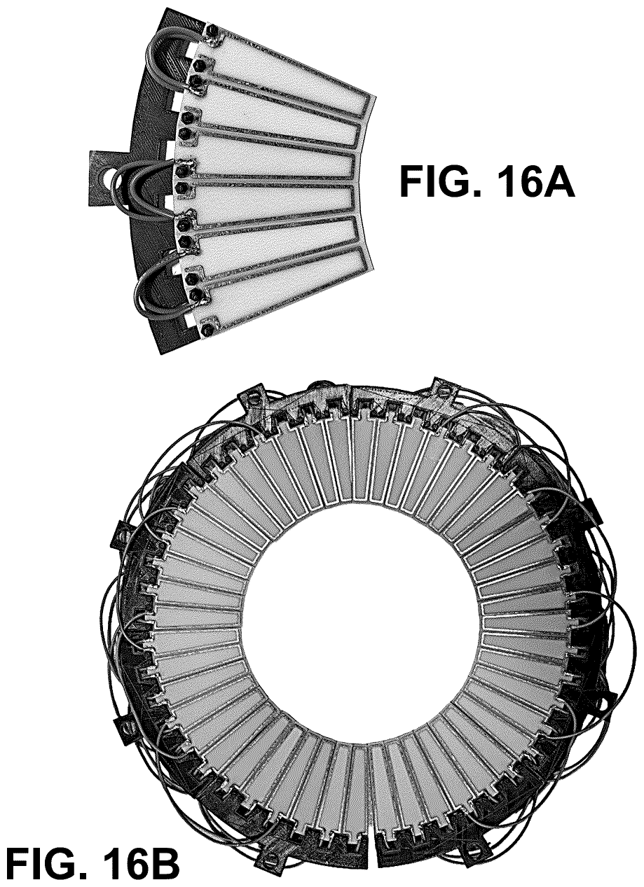

The stator coils are held together by additively manufactured coil holders on the outer periphery, with a total of 8 coil holders for the full machine, each holding 6 coils. The material used for the coil holders was polylactide (PLA). A set of coils attached to a single coil holder is shown in FIG. 16A. The complete assembly of stator coils to form the coreless axial flux stator is shown in FIG. 16B.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A ceramic substrate coil, comprising:
a ceramic substrate; and
at least one coil trace disposed on a first surface of the ceramic substrate, the at least one coil trace forming at least a partial loop about the ceramic substrate surface.

2. The ceramic substrate coil of claim 1, comprising a plurality of coil traces disposed on the first surface of the ceramic substrate.

3. The ceramic substrate coil of claim 2, wherein each of the plurality of coil traces are concentrically disposed on the first surface of the ceramic substrate.

4. The ceramic substrate coil of claim 1, comprising at least one coil trace disposed on a second surface of the ceramic substrate.

5. The ceramic substrate coil of claim 4, comprising a plurality of coil traces disposed on the second surface of the ceramic substrate.

6. The ceramic substrate coil of claim 4, wherein the at least one coil trace on the first surface of the ceramic substrate is connected to the at least one coil trace on the second surface of the ceramic substrate.

7. The ceramic substrate coil of claim 6, wherein the at least one coil traces are connected by a via or by a wire bond.

8. The ceramic substrate coil of claim 1, wherein the at least one coil trace has a rectangular shape.

9. The ceramic substrate coil of claim 1, wherein the at least one coil trace has a triangular or trapezoidal shape.

10. The ceramic substrate coil of claim 1, wherein the ceramic substrate is a planar substrate.

11. The ceramic substrate coil of claim 1, wherein the ceramic substrate is formed of aluminum nitride, aluminum oxide, or silicon nitride.

12. The ceramic substrate coil of claim 1, wherein the at least one coil trace comprises a copper trace disposed on the ceramic substrate by electroplating, direct bonding, or active metal brazing.

13. A permanent magnet machine, comprising:
a rotor; and
a stator comprising:
a plurality of ceramic coils, each of the plurality of ceramic coils comprising a ceramic substrate and at least one coil trace disposed on a first surface of the ceramic substrate, where the plurality of ceramic coils are positioned and the at least one coil traces are connected to form a stator winding of the permanent magnet machine.

14. The permanent magnet machine of claim 13, wherein each of the plurality of ceramic coils comprise a plurality of coil traces disposed on the first surface of the ceramic substrate.

15. The permanent magnet machine of claim 13, wherein each of the plurality of ceramic coils comprise at least one coil trace disposed on a second surface of the ceramic substrate.

16. The permanent magnet machine of claim 13, wherein the plurality of ceramic coils are positioned to form a radial flux stator winding.

17. The permanent magnet machine of claim 13, wherein the plurality of ceramic coils are positioned to form an axial flux stator winding.

18. The permanent magnet machine of claim 13, wherein the at least one coil traces are connected by a combination of vias and external wire bonds.

19. The permanent magnet machine of claim 13, wherein the stator comprises a heat sink disposed adjacent to a second side of the ceramic substrate.

20. The permanent magnet machine of claim 19, wherein the heat sink comprises a water jacket.
